(19) United States
(12) Patent Application Publication
(10) Pub. No.: US 2021/0143495 A1
(43) Pub. Date: May 13, 2021

(54) COOLING FRAME

(71) Applicant: Mahle International GmbH, Stuttgart (DE)

(72) Inventors: Manuel Klingler, Berglen (DE); Erik Person, Stuttgart (DE)

(21) Appl. No.: 17/092,210

(22) Filed: Nov. 6, 2020

(30) Foreign Application Priority Data
Nov. 7, 2019 (DE) 102019217240.7

(51) Int. Cl. H01M 10/6555; H01M 10/613; H01M 10/625; H01M 10/6557; H01M 50/211; H01M 50/249; H01M 50/289; B60K 1/04; B60L 58/26; F28F 3/12

(52) U.S. Cl. CPC H01M 10/6555; H01M 10/613; H01M 10/625; H01M 10/6557; H01M 50/211; B60K 2001/005; H01M 50/289; B60K 1/04; B60L 58/26; F28F 3/12; H01M 2220/20; H01M 50/249

(57) ABSTRACT

A cooling frame for an inter-cellular cooling of an energy store having battery cells includes a plate-like frame having an inlet and an outlet for cooling fluid. The plate-like frame includes an interior cooling channel that leads from the inlet to the outlet. A film is disposed on each of a front side and a back side of the plate-like frame. The film bounds the interior cooling channel perpendicularly to a plate plane and is tightly connected to the plate-like frame.

### CROSS-REFERENCE TO RELATED APPLICATION

This application claims priority to German Application No. DE 10 2019 217 240.7 filed on Nov. 7, 2019, the contents of which are hereby incorporated by reference in its entirety.

### TECHNICAL FIELD

The present invention relates to a cooling frame for an inter-cellular cooling of an energy store, preferentially pouch cells. The invention additionally relates to an electrical energy store having at least one such cooling fame and to a motor vehicle, in particular an electrical vehicle or a hybrid vehicle, having such an electrical energy store.

### BACKGROUND

In vehicles that are purely driven by electric motor just as with plug-in hybrid vehicles, individual battery cells are usually combined into modules. There, so-called pouch cells are also often used, which are held in position by suitable frames or holders and are clamped together via a clamping device. In order to be able to bring about an optimal power output of the energy store by way of this, the same should be operated in a likewise optimal temperature window, namely both during the power output and also during a charging process.

However, disadvantageous with the energy stores with flexible pouch cells known today is that the same, because of the clamping, often lie directly against one another and are only cooled via a bottom-side or circumferential cooling, as a result of which an optimal heat dissipation or cooling cannot necessarily be achieved. Moreover, by way of such a bottom-side or surrounding cooling, for example by way of cooling plates, no or merely a marginal support of the pouch cells is possible. Since in the case of pouch cells however a slight bloating of the cells can occur through ageing under certain conditions even with regular operation, the housing surrounding the pouch cells has to absorb this, just like the cooling plates arranged there.

The present invention therefore deals with the problem of stating a cooling frame by means of which both an optimised cooling and also an age-related supporting of so-called pouch cells is possible.

According to the invention, this problem is solved through the subject of the independent claim(s). Advantageous embodiments are subject of the dependent claims.

### SUMMARY

The present invention is based on the general idea of stating a cooling frame which in the installed state is arranged between two adjacent pouch cells and which in the direction of the pouch cells has a flexible surface which on the one hand lies optimally, i.e. flat and heat-transferringly against the respective outer sleeve of the pouch cell and on the other hand is additionally able to offset certain swelling effects of the pouch cells, for example caused by ageing effects. The cooling frame according to the invention therefore comprises a plate-like frame with a circumferential outer edge, wherein this plate-like frame comprises an inlet and an outlet for cooling fluid. Within the plate-like frame an internal cooling channel is located, in the course of which flow-guiding elements can be arranged, wherein the cooling channel leads from the inlet to the outlet. On a front side and a back side of the frame a film, for example an aluminium film or another heat-conductive film, in particular also of plastic, is applied in each case, which bounds the cooling channel perpendicularly to the plate plane and which is tightly connected to the frame or if applicable the flow-guiding elements. The frame and if applicable the flow-guiding elements form fastening points for the film and additionally make possible a supporting of adjacent pouch cells in the energy store. By way of the film pulled over the front side and the back side in turn a surface that is flexible towards the respective pouch cell is created, which can offset certain deformations of the pouch cell and nevertheless always lies flat against the same, as a result of which an optimal heat transfer can be achieved. Through the arrangement of such a cooling frame between two cells it is thus possible, by means of a single cooling frame, to cool two adjacent pouch cells. In addition, the cooling frame makes possible a clamping of the individual pouch cells and supports these in the process.

In an advantageous further development of the solution according to the invention the frame is designed as plastic injection moulded part or as extruded profile, in particular of plastic. A design of the frame as plastic injection moulded part makes possible a comparatively cost-effective yet high-quality production. A design as extruded profile also makes possible such a cost-effective and high-quality production since a suitable die has to be merely designed once. By cutting to size the length of the extruded profile, the thickness of the respective frame and thus also the thickness of the respective cooling frame can be easily adjusted, since the film applied to the front side and back side usually has no thickness to speak of.

In a further advantageous embodiment of the solution according to the invention, the films are welded to the frame and the flow-guiding elements, in particular ultrasound-welded or glued. Alternatively it is also conceivable that the films are directly welded to one another, in particular ultrasound-welded, sealed or glued, and the frame is located inside. Even this incomplete list gives an indication of the manifold connecting options of the films to the frame that are available, wherein it merely has to be ensured that the film is tightly connected to the frame and the flow-guiding elements in order to seal the cooling channel to the outside and avoid an undesirable bypass flow within the frame.

Generally, at least one of the films can also be formed as a composite component, i.e. for example of multiple layers, in particular of a bonding layer and a heat conducting layer.

Practically, the inlet and the outlet are arranged on a common outer edge of the frame, i.e. on a single side. Here, the frame comprises two opposite longitudinal edges with first flow-guiding elements projecting to the inside and a central web with second flow-guiding elements projecting to the outside, wherein the second flow-guiding elements project between the first flow-guiding elements and bring about a meander-like or zigzag-like U-flow of the cooling fluid in the cooling channel. Such an embodiment offers a frequent deflection of the cooling fluid flowing in the cooling channel because of the meander-like inter-engaging first and second flow-guiding elements, as a result of which a turbulent flow is generated, which makes possible a particularly effective and efficient heat transfer. In addition, a comparatively large supporting area for the adjacent pouch cells can be created through the middle web and the first flow-guiding elements projecting from the outer edge to the inside and the second flow-guiding elements projecting from the web to the outside, which in particular is of great advantage during a clamping of the same. In the places that are not connected to the flow-guiding elements or the outer edge or the frame, the respective film spans the cooling channel and in this region offers the possibility of a flexible yield, as a result of which deformations of the pouch cell do not result in a cancellation of a contact surface, such as for example with cooling blades, but a steady and large-surface contact for the heat transfer is retained.

In a further advantageous embodiment of the solution according to the invention, the inflow and the outflow are arranged on opposite outer edges, i.e. on opposite sides of the frame. In this case, the frame has longitudinal webs which interconnect the two outer edges or the two opposite sides, wherein additionally two collectors are provided, which engage about the two outer edges. In this case, the cooling fluid flows from the first collector via a side into the respective cooling channel of the cooling frame and from there between the longitudinal webs along as far as to the opposite outer edge, at which prior to the reaching of the outer edge, it again emerges from the plane of the cooling frame and enters the second collector. In this case, the cooling channels are formed linearly and extend parallel to one another from the inlet to the outlet. Through a modification of the longitudinal webs, for example a bend of the same or insertion of corners, almost any course of the cooling channel or of individual cooling channels within the frame can be enforced, which results in the possibility for example of increasingly cooling overheated locations and because of this achieve an optimised temperature-control of the energy store.

Practically, the films extend at least partly over the collector and are tightly connected with the same. In this case, the two collectors are initially put over the two opposite outer edges of the frame and a film each is applied to the front side and the back side of the frame and parts of the respective collector, in particular welded on or glued on, only subsequently. By way of the shape of the two collectors, for example in the manner of a slope projecting out of the plane of the frame, a positioning aid for pouch cells can be additionally formed. Such a positioning aid can be additionally arranged also on the outer edge of the cooling frame or of the plate-like frame, for example in the manner of a flange which likewise contributes to fixing the pouches in place.

Regardless of the selected embodiment it is obviously clear that the individual cooling frames are connected to a cooling fluid-conducting system, which can obviously be not only used for cooling but if applicable also for heating the pouch cells, in order to be able to keep these in a temperature window that is optimal for the power output and for a rapid charging.

Furthermore, the present invention is based on the general idea of stating an energy store having at least two pouch cells, between which such a cooling frame as described before is arranged. By way of this, an optimised cooling and thus an operation of the energy store that is optimal in terms of the output can be achieved, wherein such an energy store can be arranged for example in an electrical vehicle or hybrid vehicle in which for the range the output of the energy store is crucially important.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically

FIG. 1 an energy store according to the invention having two cooling frames according to the invention,

FIG. 2 a cooling frame according to the invention in a view with partly removed film,

FIG. 3 a representation as in FIG. 2, however with another cooling channel structure,

FIGS. 4 and 5 different shapes of cooling channels,

FIG. 6 a sectional representation through an electric energy store according to the invention having a cooling frame arranged between two pouch cells in a first embodiment,

FIG. 7 a representation as in FIG. 6, however with a cooling frame in a second embodiment.

### DETAILED DESCRIPTION

According to FIG. 1, an electric energy store 1 comprises multiple pouch cells 2 as energy storage cells, between which spacers 3 or cooling frames 4 according to the invention are arranged. The cooling frames 4 according to the invention make possible an inter-cellular cooling and also help keeping the electric energy store 1 in a temperature window that is optimal for the operation.

The cooling frame 4 according to the invention has a plate-like frame 5 (see also the FIGS. 2, 3 as well as 6 and 7), which comprises an inlet 6 and an outlet 7. The plate-like frame 5 contains an interior cooling channel 8 or multiple thereof, in the course of which flow-guiding elements 9 (see FIG. 2) can be arranged for example, in order to achieve a turbulent flow of a cooling fluid 10 and thus an improved heat transfer. On the front side 11 and on a back side 12 (see also the FIGS. 2, 3 as well as 6 and 7), a film 13 is applied in each case which according to the FIGS. 2 and 3 is merely shown partly in order to illustrate the interior of the frame 5 and in particular the course of the cooling channel 8 arranged therein. The films 13 bound the cooling channel 8 perpendicularly to the plate plane and are tightly connected to the frame 5 and if applicable tightly to the flow-guiding elements 9.

The frame 5 itself can be formed for example as plastic injection-moulded part but alternatively also as an extruded profile, for example from plastic or aluminium. Both embodiments allow a production that is both cost-effective and of a high quality.

In order to bound the cooling channel 8 perpendicularly to the plate plane, i.e. according to the FIGS. 2 and 3 perpendicularly to the sheet plane and according to the FIGS. 6 and 7 in the sheet plane, the films 13 are welded to the frame 5 and if applicable to the flow-guiding elements 9, in particular ultrasound-welded or tightly bonded.

With the cooling frame 4 according to the invention it is possible for the first time, by means of the same, to achieve both a supporting both of the individual pouch cells 2 and also an optimised cooling of the same through the flexible surface by means of the films 13. In addition, the films 13 bring about that under certain conditions deformations of the pouch cells 2 that occur as a result of age can be offset and nevertheless a flat and thus favourably heat-transferring contact between the film 14 and the pouch cell 2 can be ensured.

Viewing the cooling frame 4 according to FIG. 2 it is noticeable that in this case the inlet 6 and the outlet 7 are arranged on a common outer edge of the frame 5, here on the left side. In addition to this, the frame 5 comprises two opposing longitudinal edges 14, 14′ with first flow-guiding elements 9, 9a projecting to the inside and a central web 15 with second flow-guiding elements 9, 9b projecting to the outside, wherein the second flow-guiding elements 9, 9b project between the first flow-guiding elements 9, 9a and because of this enforce a meander-like flow of the cooling fluid 10, as a result of which the same is conducted in the cooling channel 8 in a turbulent manner and thus has a high heat transfer rate. Because of the fact that with the embodiment shown according to FIG. 2 the inlet and the outlet 7 are arranged on a common side, this cooling frame 4 according to the invention is flowed through in a U-shaped manner.

Viewing by contrast the cooling frame 4 according to FIG. 3 it is evident on the same that the inlet 6 and the outlet 7 are arranged on opposite outer edges, here on the left and on the right side of the frame 5. The frame 5 itself has longitudinal webs 16 which interconnect the two outer edges. In such an embodiment, collectors 17a, 17b (see the FIGS. 6 and 7) can be additionally provided, which engage about the two outer edges with the respective inlet 6 and the outlet 7.

In this case, the films 13 can extend at least partly over the collectors 17a, 17b and be tightly connected to the same. The longitudinal webs 16 can, as shown in FIG. 3, run in a straight line or, as shown according to FIG. 3, bent, or, according to FIG. 5, have corners 18. Additionally or alternatively it can also be provided that the longitudinal webs 16 comprise openings 21a, in particular punch-outs (see FIG. 4).

In addition to this, the cooling frame 4 can comprise flanges 19 on an outer edge, via which a positioning aid for the adjacent pouch cells 2 is provided (see FIGS. 3 and 7).

Now viewing FIG. 6 it is noticeable on the same that the cooling frame 4 according to the invention comprises a frame 5 and collectors 17a, 17b arranged thereon on the end side. In the finish-mounted state, the two pouch cells 2 preferentially lie flat against the associated films 13 of the cooling frame 4 in order to be able to achieve an optimal heat transfer and thus an optimal cooling and an areal support. The films 13 themselves can be plastic films for example, as a result of which an additional electrical insulation can be waived. By way of the collector 17a, cooling fluid 10 thus flows into the cooling channel 8 of the frame 5, wherein the cooling channel 8 is bounded by the frame 5 and the two films 13 that are tightly connected to the same on the front side 11 and the back side 12. Having flowed through the frame 5, the cooling fluid 10 laterally emerges from the opposite collector 17b from the frame 5, wherein it is clearly noticeable that the two collectors 17a, 17b engage about the respective outer edge of the frame 5. Between the pouch cells 2 and the cooling frame 4 a small gap is drawn in which however merely serves for a better drawing representation, so that in the finish-mounted state the pouch cells 2 are directly placed against the respective films 13 of the cooling frame 4.

Viewing the energy store 1 according to the invention as per FIG. 7, it is noticeable in the same that the two collectors 17a, 17b are embodied longer, as a result of which the same can additionally cool the tabs 20 of the pouch cells 2. In the region of the tabs 20, the collectors 17a, 17b each have openings 21 which are covered by the respective film 13, so that a direct contact of the cooling fluid 10 via the film 13 with the tab 20 of the respective pouch cell 2 can take place here. Through the openings 21 in the collector 17a, 17b and a covering of these with the film 13, an additional cooling of arrester regions of pouch cells 2 can take place. In this case, the film 13, because of the interior pressure loading, lies against the arrester and thereby cools the arrester.

Because of the circumstance that the two collectors 17a, 17b engage about the respective outer edges of the frame 5 of the cooling frame 4, the cooling fluid 10 enters the frame 5 and thus the cooling channel 8 laterally.

The cooling frame 4 according to the invention and the energy store 1 according to the invention can be employed in a motor vehicle, for example in an electric or hybrid vehicle 22.

Altogether, multiple functions can be achieved simultaneously with the cooling frame 4 according to the invention. On the one hand, a supporting of the individual pouch cells 2, in particular during the clamping during the assembly, can take place by means of the comparatively stable frame 5 of the cooling frame 4, while by means of the comparatively flexible films 13, which bound the cooling channel 8 in the frame 5, a resilience for example for expanding pouch cells 2 is provided, just like a reliable long-term contacting of the pouch cells 2, which compared with flat cooling blades makes possible a significantly increased heat transfer and thus a significantly improved cooling output.

1. A cooling frame for an inter-cellular cooling of an energy store having battery cells, comprising:
a plate-like frame having an inlet and an outlet for cooling fluid, wherein the plate-like frame includes an interior cooling channel that leads from the inlet to the outlet, and
a film disposed on each of a front side and a back side of the plate-like frame, wherein the film bounds the interior cooling channel perpendicularly to a plate plane and is tightly connected to the plate-like frame.

2. The cooling frame according to claim 1, wherein the plate like frame is a plastic injection-moulded part or an extruded profile.

3. The cooling frame according to claim 1, wherein one of:
the film is welded to the plate-like frame, and
the film disposed on the front side and on the back side are directly welded to one another, and the plate-like frame is situated inside.

4. The cooling frame according to claim 1, wherein:
the inlet and the outlet are arranged on a common outer edge of the plate-like frame, and
the plate-like frame includes two opposite longitudinal edges with first flow-guiding elements projecting to an inside and a central web with second flow-guiding elements projecting to an outside, wherein the second flow-guiding elements project between the first flow-guiding elements.

5. The cooling frame according to claim 1, wherein:
the inlet and the outlet are arranged on opposite outer edges of the plate-like frame,
the plate-like frame includes longitudinal webs that interconnect the two outer edges, and
two collectors are provided that engage about the two outer edges.

6. The cooling frame according to claim 5, wherein at least one of:
the film on at least one of the front side and the back side extends at least partly over the two collectors and is tightly connected to the two collectors, and
the film covers openings in a region of tabs of the two collectors.

7. The cooling frame according to claim 5, wherein at least one of:
the longitudinal webs are linear or bent or have corners, and
the longitudinal webs have openings.

8. The cooling frame according to claim 1, further comprising flanges disposed on an outer edge, structured and arranged as positioning aids for pouch cells.

9. An electric energy store, comprising:
at least two battery cells;
a cooling frame arranged between the at least two battery cells, the cooling frame including:
a plate-like frame having an inlet and an outlet for cooling fluid, wherein the plate-like frame includes an interior cooling channel that leads from the inlet to the outlet; and
a film disposed on each of a front side and a back side of the plate-like frame, wherein the film bounds the interior cooling channel perpendicularly to a plate plane and is tightly connected to the plate-like frame.

10. The energy store according to claim 9, further comprising a spacer arranged between two adjacent battery cells.

11. A motor vehicle, comprising: an electric energy store, the electric energy store including:
at least two battery cells;
a cooling frame arranged between the at least two battery cells, the cooling frame including:
a plate-like frame having an inlet and an outlet for cooling fluid, wherein the plate-like frame includes an interior cooling channel that leads from the inlet to the outlet; and
a film disposed on each of a front side and a back side of the plate-like frame, wherein the film bounds the interior cooling channel perpendicularly to a plate plane and is tightly connected to the plate-like frame.

12. The motor vehicle according to claim 11, further comprising a spacer arranged between two adjacent battery cells.

13. The energy store according to claim 9, wherein the film is welded or glued to the plate-like frame.

14. The energy store according to claim 9, wherein the inlet and the outlet are arranged on a common outer edge of the plate-like frame; and
wherein the plate-like frame includes two opposite longitudinal edges with first flow-guiding elements projecting to an inside and a central web with second flow-guiding elements projecting to an outside, wherein the second flow-guiding elements project between the first flow-guiding elements.

15. The energy store according to claim 9, wherein:
the inlet and the outlet are arranged on opposite outer edges of the plate-like frame;
the plate-like frame includes longitudinal webs that interconnect the two outer edges; and
two collectors are provided that engage about the two outer edges.

16. The energy store according to claim 15, wherein the film on at least one of the front side and the back side extends at least partly over the two collectors and is tightly connected to the two collectors.

17. The energy store according to claim 15, wherein the film covers openings provided in a region of tabs of the two collectors.

18. The energy store according to claim 15, wherein the longitudinal webs are linear or bent or have corners.

19. The energy store according to claim 15, wherein the longitudinal webs have openings.

20. The energy store according to claim 9, wherein the cooling frame includes flanges disposed on an outer edge thereof, structured and arranged as positioning aids for the at least two battery cells.
